(19) United States
(12) Patent Application Publication
(10) Pub. No.: US 2009/0144347 A1
(43) Pub. Date: Jun. 4, 2009

(54) STORAGE VOLUME SPANNING WITH INTELLIGENT FILE PLACEMENT AND/OR REARRANGEMENT

(76) Inventors: James A. Boyd, Hillsboro, OR (US); Amber Huffman, Bank, OR (US); Knut Grimsrud, Forest Grove, OR (US)

Correspondence Address: INTEL CORPORATION;c/o CPA Global, P.O. BOX 52050, MINNEAPOLIS, MN, 55402, US

(21) Appl. No.: 11/948,162

(22) Filed: Nov. 30, 2007

(51) Int. Cl. G06F 12/00; G06F 12/02

(52) U.S. Cl. 707/205; 711/103; 711/112; 711/E12.001; 711/E12.008

(57) ABSTRACT

In some embodiments a determination is made as to whether a file is to be placed on a slower drive of a logical storage volume span or a faster drive of the logical storage volume span. The file is placed on the slower drive or the faster drive based on the determining, and a user does not need to be aware of whether the file has been placed on the slower drive or the faster drive. Other embodiments are described and claimed.

### TECHNICAL FIELD

The inventions generally relate to storage volume spanning with intelligent file placement and/or rearrangement.

### BACKGROUND

A computer system may include one or more central processing units (CPUs) or processor(s). The CPU(s) may be coupled to a chip set (for example, via a bus). The chipset may include a memory controller hub (MCH) including a memory controller coupled to a system memory. The system memory stores data and responds to the memory controller through a sequence of instructions that are executed by the CPU(s) or processing device(s) included in the computing system. The MCH may also include, for example, a display controller coupled to a display. The chipset further may include an input/output control hub (ICH) coupled, for example, to the MCH via a hub interface. The ICH may be coupled, for example, to one or more input/output (I/O) devices. The ICH may also be coupled to a peripheral bus (for example, a Peripheral Component Interconnect or PCI bus). A PCI bridge may be coupled to the PCI bus to provide a data path between the CPU(s) and peripheral devices. The ICH is often coupled to a storage device or storage devices including, for example, one or more hard drives.

### BRIEF DESCRIPTION OF THE DRAWINGS

The inventions will be understood more fully from the detailed description given below and from the accompanying drawings of some embodiments of the inventions which, however, should not be taken to limit the inventions to the specific embodiments described, but are for explanation and understanding only.

FIG. 1 illustrates a system according to some embodiments of the inventions.

FIG. 2 illustrates a flow according to some embodiments of the inventions.

FIG. 3 illustrates a system according to some embodiments of the inventions.

FIG. 4 illustrates a system according to some embodiments of the inventions.

### DETAILED DESCRIPTION

Some embodiments of the inventions relate to storage volume spanning with intelligent file placement and/or rearrangement.

In some embodiments a determination is made as to whether a file is to be placed on a slower drive of a logical storage volume span or a faster drive of the logical storage volume span. The file is placed on the slower drive or the faster drive based on the determining, and a user does not need to be aware of whether the file has been placed on the slower drive or the faster drive.

In some embodiments a system includes a logical storage volume span including a faster drive and a slower drive. A controller determines whether a file is to be placed on the slower drive or on the faster drive, and places the file on the slower drive or the faster drive. A user does not need to be aware of whether the file has been placed on the slower drive or the faster drive.

In some embodiments an article includes a computer readable medium having instructions thereon which when executed cause a computer to determine whether a file is to be placed on a slower drive of a logical storage volume span or a faster drive of the logical storage volume span, and to place the file on the slower drive or the faster drive based on the determining. A user does not need to be aware of whether the file has been placed on the slower drive or the faster drive.

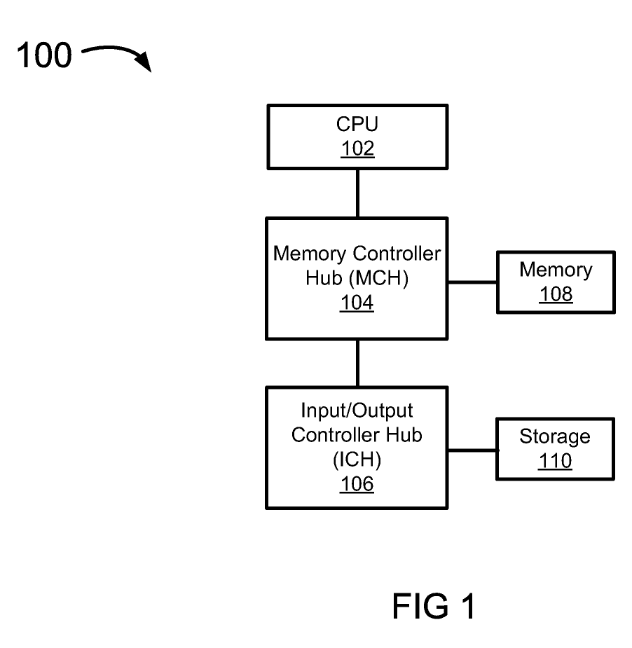

FIG. 1 illustrates a system 100 according to some embodiments. In some embodiments system 100 is a computer system. In some embodiments system 100 is a storage system. In some embodiments system 100 includes a central processing unit (CPU) or a processor 102, a Memory Controller Hub (MCH) 104, an Input/Output Controller Hub (ICH) 106, a memory 108, and a storage device 110. MCH 104 includes a memory controller that controls actions of the memory 108 (for example, read, write, etc.) The CPU 102 is coupled to the MCH 104, and the MCH 104 is also coupled to ICH 106 and the memory 108 as illustrated in FIG. 1. THE ICH 106 is coupled to a storage device 110 (for example, including one or more hard disk drives and/or one or more solid state disks (SSDs). In some embodiments all or some of the elements of system 100 are resident on a motherboard. In some embodiments, different partitioning between blocks may exist such as the memory controller being included in the CPU block instead of the MCH block, for example.

In some embodiments, system 100 includes more than one CPU, and is not limited to one CPU 102 as illustrated in FIG. 1. In some embodiments the CPU(s) of the system 100 may be coupled to a chip set (for example, via a bus for each CPU and/or via a common bus). The chipset may include memory controller hub (MCH) 104 and input/output controller hub (ICH) 106. In some embodiments memory 108 may store data and/or sequences of instructions that are executed by the CPU(s) or processing device(s) included in the computing system. In some embodiments the MCH 104 may also include, for example, a display controller coupled to a display. In some embodiments the ICH 106 may be coupled, for example, to the MCH 104 via a hub interface. In some embodiments the ICH 106 may also be coupled, for example, to one or more input/output (I/O) devices (including but not limited to storage device 110). In some embodiments the ICH 106 may also be coupled to a peripheral bus (for example, a Peripheral Component Interconnect or PCI bus). A PCI bridge may be coupled to the PCI bus to provide a data path between the CPU 102 and peripheral devices such as storage device 110.

As mentioned above, in some embodiments, storage device 110 includes one or more hard disk drives. However, the performance of spindle based (that is, mechanical) hard drives has not been increasing at a rate that keeps pace with the rest of the computer system or computer platform. As CPU performance has continued to scale proportionally, hard drives have improved only logarithmically, for example. For many workloads, the performance bottleneck is clearly the hard drive. Therefore, in some embodiments, storage device 110 includes one or more hard disk drives and also includes one or more solid state disk (SSD) drives. In some embodiments storage device 110 includes one or more slower (and/or higher capacity) drives and one or more faster (and/or lower capacity) drives.

Recently, it has become apparent that new technologies may be used to increase an effective hard drive speed (for example, using non-volatile solid-state memories such as flash memories, NAND memories, etc.) One alternative is to use solid state disks (SSDs), which do not have the same performance limitations of mechanical disk drives. However, the cost per bit of a non-volatile solid-state memory is much higher than that of traditional spindle based hard drives. As a result, the capacity of non-volatile solid-state memories is modest when compared with mechanical hard disk drives.

In some embodiments a solution is provided that bridges between the capacity benefits of a larger capacity slower mechanical hard drive and the speed benefits of the smaller capacity faster solid state disk (SSD) drives. This is particularly advantageous in applications where a user needs storage capacity beyond what is offered in a cost-effective SSD. In some embodiments, volume spanning of one or more slower (and/or higher capacity) drives (for example, a mechanical hard disk drive or HDD such as a spindle based hard drive) and one or more faster (and/or lower capacity) drives (for example, a solid state disk drive) is performed with intelligent file placement and/or rearrangement. In some embodiments, for example, file placement with a volume is based on file type, and/or based on file size, and/or based on a type of access of the file (for example, sequentially accessed files on the slower and/or rotating drive and/or random accessed files on the faster and/or solid state drive), and/or based on usage heuristics.

In some embodiments files may be moved to the faster drive and/or slower drive based on their file size. This may be relative to the file size rather than the capacity of the faster and/or slower drives. For example, in some embodiments a smaller file size may have a preference for placement on the smaller and/or faster drive over the preference of a larger file size even if they are heuristically determined to be the same.

In some embodiments one or more factors such as file type, file size, file access counts, file access types (for example, random and/or sequential), available space on the faster drive (and/or SSD) and/or available space on the slower drive (and/or HDD), for example, are taken into consideration in a holistic fashion to determine file placement, rather than looking at each file in isolation and making a determination, for example.

In some embodiments, heuristics may include taking into account power management, for example, and/or placing new files (for example, new temporary files) onto the faster drive (for example, solid state drive) in order to keep for example, the slower drive from operating (for example, to keep a power hungry hard disk drive spun down). In some embodiments, heuristics may be based on user and/or manufacturer selection of which files to put on each medium. In some embodiments, files may be moved between a faster drive and a slower drive with a user completely unaware of the movement. That is, for example, in some embodiments a faster drive and a slower drive form a logical disk array with movement of files between the faster drive and the slower drive in a manner that is transparent to a user. In some embodiments, prioritization of placement of files is made in a manner that is dependent upon a size of the faster drive (for example, a solid state drive). In some embodiments a system configuration file is used to direct where files are placed. In some embodiments a manufacturer of the system directs how prioritization of file placement should be implemented (for example, an Original Equipment Manufacturer or OEM “pinning” info). In some embodiments file placement prioritization is implemented based on a type of access for the file. For example, in some embodiments, sequentially accessed files are placed on the slower drive (and/or rotating hard drive) and/or random accessed files are placed on the faster drive (and/or solid state drive).

In some embodiments, in order to deliver both the high performance of a faster speed drive (for example, an SSD-based system) and the vast storage capacity of a slower speed drive (for example, a mechanical drive based system and/or a spindle drive based system), a system is provided that includes both a high speed drive and a slower (and/or larger) drive. In some embodiments a faster drive and a slower drive may be implemented without requiring a user to see two separate drives (for example, a C: drive and a D: drive). In some embodiments, a user is able to access both drives as separate drives that keep data the user wants most often on the faster drive and less used data on the slower drive. However, this would take constant user effort and a certain level of expertise for the user to know about file usage frequency and other technical issues of which the user may not be familiar. Therefore, it is advantageous in some embodiments to use a logical volume span with intelligent file placement and/or rearrangement that does not require user interaction.

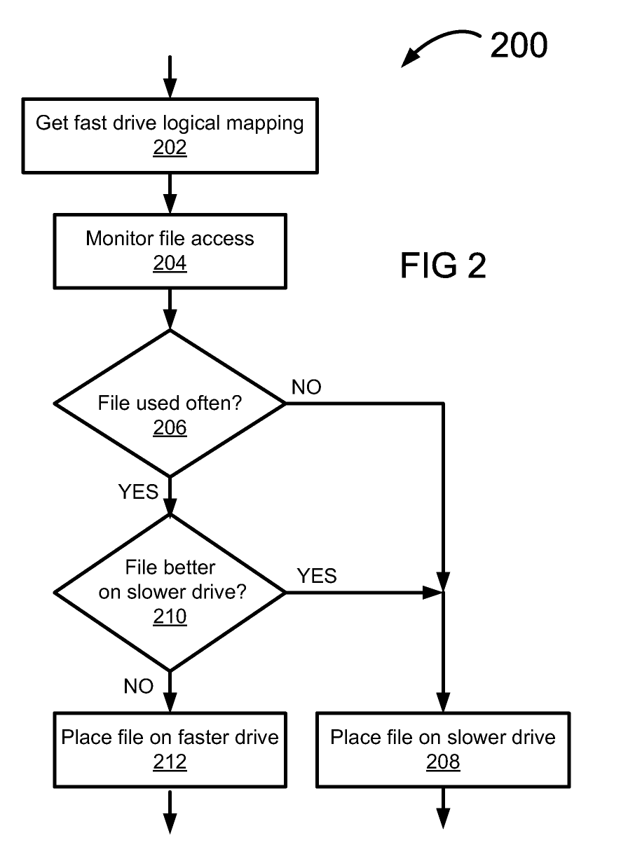

FIG. 2 illustrates a flow 200 according to some embodiments. In some embodiments, flow 200 may be implemented in software. In some embodiments flow 200 may be implemented in hardware, firmware, software, and/or any combination thereof.

Flow 200 obtains fast drive logical mapping at 202. Then a file access is monitored at 204. At 206 a determination is made as to whether the file is used often. If the file is not used often at 206 then the file is placed on a slower drive at 208. If the file is used often at 206 then a determination is made at 210 as to whether the file is better on a slower drive (for example, in some embodiments, based on a type of the file and/or based on access heuristics). If the file is better on a slower drive at 210 then the file is placed on a slower drive at 208. If the file is not better on a slower drive at 210 then the file is placed on a faster drive at 212. In some embodiments, heuristics take into account a size of the faster drive (for example, a solid state drive) to determine how much can be fit on the faster drive, and prioritize the files that should be placed on that drive (for example, in some embodiments, 50 smaller files might have a higher importance than one larger file that has the same size as the 50 smaller files combined).

In some embodiments, in order to deliver both the high performance of a faster speed drive (for example, an SSD-based system) and the vast storage capacity of a slower speed drive (for example, a mechanical drive based system and/or a spindle drive based system), a system is provided that includes both a high speed drive and a slower (and/or larger) drive.

In some embodiments, a volume spanning driver may be used with intelligent software that presents a faster storage device and a slower storage device to the user as one accessible logical address space. For example, the logical address space appears to the user as a single storage device (for example, as the “C” drive or as “C:\”). Since the two storage devices are presented to the Operating System (OS) as one logical address space, higher level software can be used to access files to this composite volume without consideration for the drives having been spanned. A software utility may be used to intelligently place and/or move files between the fast portion and the slower portion of the spanned volume contained within the logical address space based on, for example, access heuristics and/or file type. In this manner, as far as the user is concerned the system appears to have a large fast storage device. Therefore, the benefits of the high performance of the faster storage device (such as an SSD, for example) and the benefits of the larger capacity of the slower storage device (such as a mechanical drive, for example) can be realized simultaneously. It is also noted that in some embodiments the software utility displays the file placements to the user (for example, if desired by the user). In this manner the software utility is able to obtain feedback about the placement from the user.

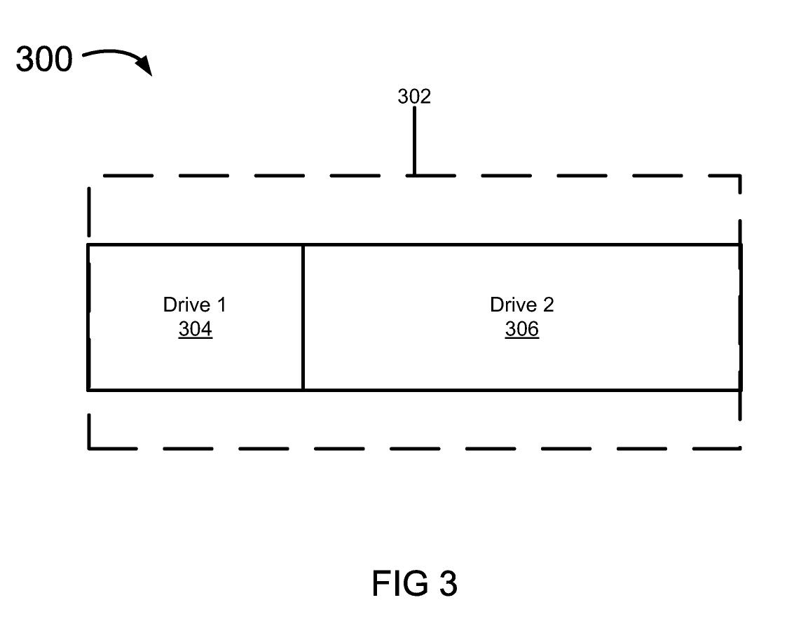

FIG. 3 illustrates a system 300 according to some embodiments. System 300 includes a logical volume span 302. In some embodiments, logical volume span 302 may be included in a system such as system 100, where logical volume 302 comprises storage 110, for example. Logical volume span 302 includes a first storage device 304 and a second storage device 306. That is, in some embodiments logical volume span 302 is a spanned volume between two drives 304 and 306. In some embodiments first storage device 304 is a faster storage device (for example, an SSD) and second storage device 306 is a slower storage device (for example, a mechanical hard drive and/or a spindle based hard drive). In FIG. 3, first storage device 304 is illustrated at the beginning of the logical volume span (for example, beginning at logical address LBA 0) and second storage device 306 is illustrated at the end of the logical volume span (for example, ending at the end of the logical addressing at logical address LBA X). However, other embodiments may be implemented where the logical addressing is different (for example, where first storage device 304 is a slower storage device and where second storage device 306 is a faster storage device). In some embodiments, a faster drive (for example, a solid state drive) at the beginning of the logical volume span is preferred since Operating System and other key files are placed on the faster drive upon an install operation.

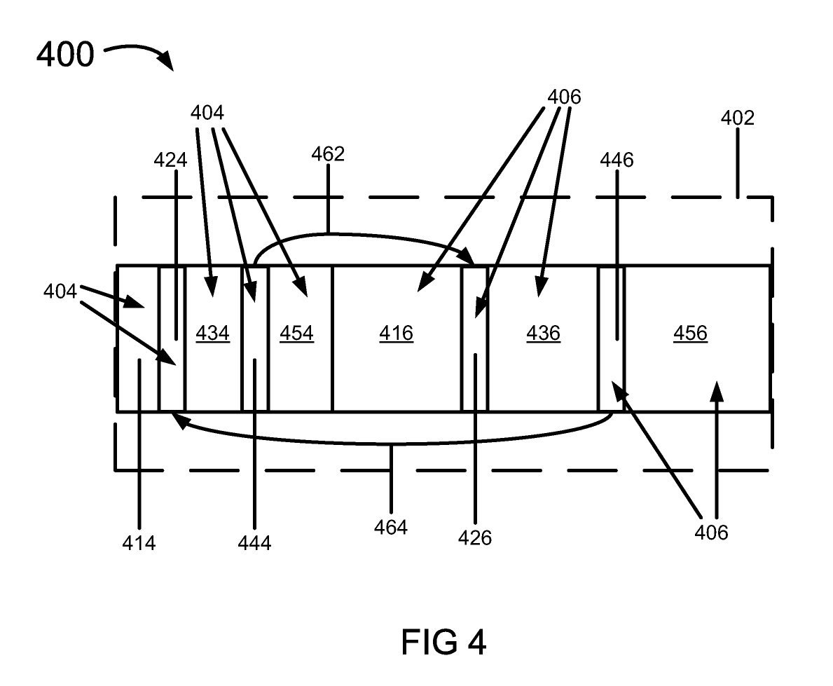

FIG. 4 illustrates a system 400 according to some embodiments. System 400 includes a logical volume span 402. In some embodiments, logical volume span 402 may be included in a system such as system 100, where logical volume 402 comprises storage 110, for example. Logical volume span 402 includes a first storage device 404 and a second storage device 406. That is, in some embodiments logical volume span 402 is a spanned volume between two drives 404 and 406. In some embodiments first storage device 404 is a faster storage device (for example, an SSD) and second storage device 406 is a slower storage device (for example, a mechanical hard drive and/or a spindle based hard drive). In FIG. 4, first storage device 404 is illustrated at the beginning of the logical volume span (for example, beginning at logical address LBA 0) and second storage device 406 is illustrated at the end of the logical volume span (for example, ending at the end of the logical addressing at logical address LBA X). However, other embodiments may be implemented where the logical addressing is different (for example, where first storage device 404 is a slower storage device and where second storage device 406 is a faster storage device).

First storage device 404 includes portions 414, 424, 434, 444, and 454. Second storage device 406 includes portions 416, 426, 436, 446, and 456. Arrow 462 in FIG. 4 illustrates how in some embodiments files in portion 444 of the first (faster) storage device 404 that are not used often, for example, are moved to portion 426 of the second (slower) storage device 406. Similarly, arrow 464 in FIG. 4 illustrates how in some embodiments files in portion 446 of the second (slower) storage device 406 that are accessed often, for example, are moved to portion 424 of the first (faster) storage device 404.

In some embodiments files that are rarely accessed (for example, help files) provide little or not benefit from being on the faster storage device and would only consume capacity on the faster storage device that could be used for higher value content (for example, application executables and/or a user working data set, etc.) In some embodiments such files can be targeted for migration to the slower storage device (the slower portion of the spanned volume).

In some embodiments other file types such as media files are usually organized and accessed on/from a storage device sequentially. Since mechanical hard disk drives perform well for sequential operations (for example with higher throughput than NAND and/or with some SSD drives) large media files are good candidates to migrate from the faster storage device to the slower storage device in some embodiments. Other files that are modified often (for example, Word files) usually fragment and may be part of the user's working set and/or may be accessed non-sequentially to begin with. Such files on a slower storage device (such as a spindle based drive) reduce performance even more as additional seek and head movement is necessitated. In some embodiments, migrating files to the faster storage device (for example, non-volatile and/or SSD storage device) eliminates this performance degradation and also has no impact upon the performance of the faster storage device, since faster storage devices such as SSDs are not adversely impacted by fragmentation.

In some embodiments a software utility is made aware of where the faster drive is located within the logical volume span (in order to know the mapping of the volume). In some embodiments this utility knows where to migrate files based on their access heuristics and/or file attributes (for example, either migrating a file to the faster drive and/or to the slower drive). In some embodiments the software utility migrates the selected files between different regions of the spanned drive by using operations logically equivalent to operations used to perform utility defragment (defrag) operations. In some embodiments this spanned intelligent operation selects and migrates files with awareness of the faster drive (for example, SSD drive) boundary in the logical address space. Although this operation can be thought of as being similar to a defrag operation in some embodiments the purpose is not to defrag. However, in some embodiments, as part of the movement files may be defragged so that the defrag operation of the Operating System is not required to defrag files on the faster drive (for example, a solid state drive).

In some arrangements, spanning a faster drive and a slower drive would only show benefits of those files placed on the faster drive. Modern Operating Systems (OSes) do not follow any particular ordering when placing files on a device (that is, on a volume). As a result, there is no guarantee which device (faster or slower) on which the file is placed. If files the user uses often are on a slower drive (for example, a spindle based drive) then no advantage is apparent to the user that the purchase and/or use of the faster drive was helpful. In some embodiments, on the other hand, by intelligently moving files to the faster drive that the user interacts with more often and/or by intelligently moving files to the slower drive that are accessed by the user less often, a performance advantage is apparent to the user regardless of initial file placement and without a need for the user to manually select different logical drive letters for the files (that is, as far as the user is concerned all files are resident on the same logical drive). In some embodiments, a portion of the faster drive (for example, a solid state drive) is left unused so that temporary file creation (for example, temporary file creation by the Operating System) will be able to use this unused space to avoid using the slower drive. This will allow, for example, faster temporary file creation and/or usage, and/or a savings of power by not requiring use of the slower drive (for example, spindle type rotating hard disk drive).

In some embodiments a non-volatile SSD may be used in a system to provide more value to a customer (for example, using software). Without advantages according to some embodiments such advantages would typically be limited only to the space of the SSD device. In some embodiments a faster drive (such as a solid state drive) may be added to a system that already includes a slower drive (such as a hard disk spindle drive) to make the system faster. In some systems in which only a faster solid state drive is used a slower hard disk drive may be added (or migrated to) when more capacity is needed by the user by continuing to maintain from the perspective of the user the look and feel of the SSD only system.

In some embodiments a user is not aware of the performance difference between a slower larger storage device and a faster smaller storage device. That is, the user is only aware of a combination of the capacity of the two devices and the performance advantage of the smaller faster device.

In some embodiments a user is not made aware of whether a file has been placed on the slower drive or on the faster drive. In some embodiments a user can be made aware of whether a file has been placed on the slower driver or on the faster drive (for example, if the user desires to be made aware of the placement by providing an indication of the user's desire). In some embodiments the user provides inputs and/or preferences for desired placements (for example, placement preferences based on certain types of files, certain access types, etc.)

In some embodiments file placement is prioritized based on received file placement prioritization information (for example, from a user and/or from a manufacturer of the system). In some embodiments file placement is prioritized based on file placement prioritization pinned by a user and/or by a manufacturer of the system (for example, an original equipment manufacturer or OEM).

In some embodiments a file placement determination is made based on file placement prioritization information. In some embodiments the file placement prioritization information related to one or more of types of files, size of files, access types of files, frequency of use of files, user preference, and/or selections to reduce power consumption, for example.

Although some embodiments have been described in reference to particular implementations, other implementations are possible according to some embodiments. Additionally, the arrangement and/or order of circuit elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

In the description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Some embodiments may be implemented in one or a combination of hardware, firmware, and software. Some embodiments may also be implemented as instructions stored on a machine-readable medium, which may be read and executed by a computing platform to perform the operations described herein. A machine-readable medium may include any mechanism for storing or transmitting information in a form readable by a machine (e.g., a computer). For example, a machine-readable medium may include read only memory (ROM); random access memory (RAM); magnetic disk storage media; optical storage media; flash memory devices; electrical, optical, acoustical or other form of propagated signals (e.g., carrier waves, infrared signals, digital signals, the interfaces that transmit and/or receive signals, etc.), and others.

An embodiment is an implementation or example of the inventions. Reference in the specification to “an embodiment,” “one embodiment,” “some embodiments,” or “other embodiments” means that a particular feature, structure, or characteristic described in connection with the embodiments is included in at least some embodiments, but not necessarily all embodiments, of the inventions. The various appearances “an embodiment,” “one embodiment,” or “some embodiments” are not necessarily all referring to the same embodiments.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

Although flow diagrams and/or state diagrams may have been used herein to describe embodiments, the inventions are not limited to those diagrams or to corresponding descriptions herein. For example, flow need not move through each illustrated box or state or in exactly the same order as illustrated and described herein.

The inventions are not restricted to the particular details listed herein. Indeed, those skilled in the art having the benefit of this disclosure will appreciate that many other variations from the foregoing description and drawings may be made within the scope of the present inventions. Accordingly, it is the following claims including any amendments thereto that define the scope of the inventions.

What is claimed is:

1. A method comprising:
determining whether a file is to be placed on a slower drive of a logical storage volume span or a faster drive of the logical storage volume span; and
placing the file on the slower drive or the faster drive based on the determining;
wherein a user does not need to be aware of whether the file has been placed on the slower drive or the faster drive.

2. The method of claim 1, wherein the file is to be placed on the slower drive or on the faster drive based on a type of the file.

3. The method of claim 1, wherein the file is to be placed on the slower drive or on the faster drive based on a size of the file.

4. The method of claim 1, wherein the file is to be placed on the slower drive or on the faster drive based on a type of access of the file.

5. The method of claim 1, wherein the file is to be placed on the slower drive or on the faster drive based on access heuristics.

6. The method of claim 1, further comprising prioritizing where files are placed based on a size of the faster drive.

7. The method of claim 1, wherein the faster drive is a solid state drive.

8. The method of claim 6, wherein the slower drive is a mechanical hard drive.

9. The method of claim 1, wherein files used more often are placed on the faster drive and files used less often are placed on the slower drive.

10. The method of claim 1, wherein the determining includes prioritizing file placement based on received file placement prioritization information.

11. The method of claim 1, wherein the determining performs file placement determination based on file placement prioritization information relating to one or more of types of files, size of files, access types of files, frequency of use of files, user preference, and/or selections to reduce power consumption.

12. A system comprising:
a logical storage volume span including a faster drive and a slower drive; and
a controller to determine whether a file is to be placed on the slower drive or on the faster drive, and to place the file on the slower drive or the faster drive, wherein a user does not need to be aware of whether the file has been placed on the slower drive or the faster drive.

13. The system of claim 12, wherein the controller is to place the file on the slower drive or on the faster drive based on a type of the file.

14. The system of claim 12, wherein the controller is to place the file on the slower drive or on the faster drive based on a size of the file.

15. The system of claim 12, wherein the controller is to place the file on the slower drive or on the faster drive based on access heuristics.

16. The system of claim 12, wherein the faster drive is a solid state drive.

17. The system of claim 16, wherein the slower drive is a mechanical hard drive.

18. The system of claim 12, wherein the controller is to place files used more often on the faster drive and is to place files used less often on the slower drive.

19. The system of claim 12, wherein the controller is implemented in software.

20. An article comprising:
a computer readable medium having instructions thereon which when executed cause a computer to:
determine whether a file is to be placed on a slower drive of a logical storage volume span or a faster drive of the logical storage volume span; and
place the file on the slower drive or the faster drive based on the determining;
wherein a user does not need to be aware of whether the file has been placed on the slower drive or the faster drive.

21. The article of claim 20, wherein the file is to be placed on the slower drive or on the faster drive based on a type of the file.

22. The article of claim 20, wherein the file is to be placed on the slower drive or on the faster drive based on a size of the file.

23. The article of claim 20, wherein the file is to be placed on the slower drive or on the faster drive based on access heuristics.

24. The article of claim 20, wherein the faster drive is a solid state drive.

25. The article of claim 24, wherein the slower drive is a mechanical hard drive.

26. The article of claim 20, the computer readable medium having instructions thereon which when executed further cause a computer to place files used more often on the faster drive and to place files used less often on the slower drive.
